(19) United States
(12) Patent Application Publication
(10) Pub. No.: US 2011/0264665 A1
(43) Pub. Date: Oct. 27, 2011

(54) INFORMATION RETRIEVAL SYSTEM WITH CUSTOMIZATION

(75) Inventors: Vijay Mital, Kirkland, WA (US); Thomas Frank Bergstraesser, Kirkland, WA (US); Darryl Ellis Rubin, Duvall, WA (US)

(73) Assignee: Microsoft Corporation, Redmond, WA (US)

(21) Appl. No.: 12/767,247

(22) Filed: Apr. 26, 2010

(51) Int. Cl. G06F 17/30

(52) U.S. Cl. 707/741; 707/769; 707/E17.002; 707/E17.014

(57) ABSTRACT

A data search and retrieval system that, in response to a search query, dynamically selects and applies a model of information to be returned to a user. The model may be selected based on the search query directly or indirectly based on data returned by a search engine applying the query. For this purpose, the system may include an index of models, similar to a search index. Models may be authored and contributed to the search and retrieval system by third parties, and an association between each such contributed model and characteristics of a search query, such as specific search query terms, may be stored in the index of models. A user of the search and retrieval system may provide feedback on a model that was used to generate information in response to the user's search query, and such feedback may be used to update the index of models.

### BACKGROUND

With the widespread availability of information over networks, such as the Internet, search engines have come into widespread use. Search engines receive user queries and find content matching the query to return to the user. A common approach to implementing a search engine is through a page index. The page index relates terms that may appear in a search query to units of content on the network, frequently called web pages.

Various approaches exist for constructing and applying the page index. Constructing the index frequently entails “crawling” a network, such as the Internet, containing the body of data that will eventually be searched. Crawling entails following links from one web page to the next and analyzing each page. As part of the analysis, terms characterizing the web page may be identified and added to the page index in a way that associates that web page with those terms. These terms may be terms actually used within the context displayed by the web page or may be tags added specifically to influence how the crawler indexes the web page. Additionally, information, such as the number of links to a web page, may be captured and used to prioritize the web pages.

The page index is applied as part of a search stack. When a user submits a search query, a search engine matches terms in the query to web pages based on the search index. The search stack may include components that modify the search query before the index is consulted, such as to correct misspelling of search terms or attach terms that can be inferred based on a user profile. The search stack may also include components to filter search results. For example, web pages identified using the page index may be filtered, such as by ranking the web pages based on a metric indicating relevance to a query.

In some scenarios, information that may be useful as part of processing search queries may be pre-computed. An entry may be made in the page index, pointing to the pre-computed information rather than a web page.

Websites may expose a search engine service, allowing users to search the content of the site and possibly other sites and web domains. In such situations, the search engine service may provide simple pre-determined and parameterized ways to configure the search engine, such as by allowing operators of third party sites to prohibit search terms or to restrict which web domains are searched.

### SUMMARY

The usefulness of a search system may be improved by incorporating into a search stack of the system components that may select and apply a model characterizing information to be provided in response to a search query. The model may be selected from a set of models based on user context information, such as a search query from a user and/or data identified by a search engine in response to the search query. Application of the model may result in generation of new information, in addition to formatting, filtering or processing data returned by a search engine executing the query.

Third parties may be able to author models using a model authoring tool. The search system may be configured to receive models authored by third parties, and may store an association in an index between each contributed model and characteristics of a search query, such as terms that may be used in a search query.

A user of the search system may provide feedback on the usefulness of a model that is used to generate information returned in response to the user's search query. Such feedback may be provided explicitly, such as via a voting mechanism, or implicitly, such as by monitoring session length or number of clicks made by the user. Based on the received feedback, the search system may update the association between the model and the representations of the search.

The foregoing is a non-limiting summary of the invention, which is defined by the attached claims.

### BRIEF DESCRIPTION OF DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 is a high level block diagram illustrating a computing environment in which some embodiments of the invention may be practiced;

FIG. 2 is an architectural block diagram of a search stack according to some embodiments;

FIG. 3 is a diagram of types of statements that may comprise the specification of a declarative model;

FIG. 4 is a diagram of an example of statements, such as those that may be specified for the declarative model of FIG. 3;

FIG. 5 is a flowchart of a process that may be performed during execution by a search stack, according to some embodiments;

FIG. 6 is an example of a user interface via which a user may enter a search query and display information returned in response to the query;

FIG. 7 is a flowchart illustrating a process of receiving a model from a third party and incorporating that model into a search stack infrastructure;

FIG. 8 is a flowchart of a process for updating the association between characteristics of a search query and a model based on user feedback;

FIG. 9A is a block diagram of a model index according to a first embodiment before it has been updated based on the analyzed user feedback;

FIG. 9B is a block diagram of the model index of FIG. 9A after it has been updated based on analyzed user feedback;

FIG. 9C is a block diagram of a model index according to a second embodiment before it has been updated based on the analyzed user feedback;

FIG. 9D is a block diagram of the model index of FIG. 9C after it has been updated based on analyzed user feedback;

FIG. 10 is a flowchart of a process by which one or more users may provide model(s) and feedback on model(s) to a search stack;

FIG. 11 is an example of a user interface via which a user may provide a search query to a search system, receive information in response to the query, and provide feedback on a model to search results applied as part of processing the query; and

FIG. 12 is an example of a user interface that allows a user to explicitly provide feedback on an applied model.

### DETAILED DESCRIPTION

The inventors have recognized and appreciated that functionality and utility of search systems may be expanded by incorporating into a search stack of a search system components that can select and apply one or more models characterizing data to be provided to a user in the user's context, and also characterizing the interactions between the data and user. In response to a search query, or other input identifying user context, the system may identify a model to apply in generating information for the user, and to handle further interactions between the user and the information (as the user seeks to better understand the information or subsets of the information, including by providing more data). The model may be selected based on user context information, that may include the search query itself or data generated by a search engine applying the search query to select web pages.

Once a model is selected, a model application engine may apply the model to generate information to be provided to the user. A model may include one or more elements, at least some of which define a computation to be performed based on data dynamically identified for the user's context. For example, application of the model may result in a computation that has inputs relating to terms in the search query or data generated by a search engine applying the search query. The output of the computation may be provided to the user as a result of the search query, either alone or in conjunction with data located by a search engine or other dynamically generated data.

In some embodiments, the computation may be based on an equation represented in the model. The equation may specify a mathematical operation to be performed on data that is dynamically identified by the search engine. Such a mathematical operation may include other data, such as user data obtained from a user profile or based on context information. Applying models in a search stack may greatly expand the type of information that may be returned to a user and may be applied in many different contexts.

For example, a model may include an equation, defining computation of calorie content from a recipe. Such a model may be applied in response to a query requesting recipes such that, in addition to receiving content representing recipes found on web pages, a user may receive calorie content, even though that information was not included on the web pages. Such a model may allow the user to interact with the data returned by the query without going back to the search engine. For example, if a facility is provided to edit a model, a user may specify or change his personal profile and nutrition goals by editing the model and see alternative meal plans for the day. As another example, a model may include a formula for computing commuting distance or time from a location. Such a model may be applied in response to a query requesting information on houses for sale such that, in addition to receiving a listing of houses for sale identified as a result of a search, a user may receive commuting information with each house. This commuting model may be editable to let the user interact with and do what-ifs with the information, e.g. the commuting impact of particular school/gym/workplace/transportation mode choices. As yet another example, a model may include a formula for generating a metric comparing a patient's lab results to a population norm. Such a model may be applied in a search system coupled to an intranet in a hospital such that, when a search is conducted for lab results of a patient, a clinician may receive, in addition to lab results for the patient, comparative data characterizing the results based on an analysis of lab results in medical records for other users returned as a result of the search. The model may enable the clinician to do what-ifs like change some assumptions about the patient or the relationship between lab data and underlying disease.

Besides equations and/or formulae, a model may also comprise other types of statements, such as constraints and/or rules. Also, the application of a model in a search system may additionally or alternatively trigger other actions to be performed besides the generation of information to be returned to the user. Such actions may be conditionally performed based on satisfaction of a constraint in the model or based on the evaluation of a rule in the model. For example, application of a model may trigger a new search query to be performed based on the evaluation of a rule in the model.

A search system may contain multiple models, applicable in different contexts. Accordingly, a search system may contain a component that selects a model for a specific context. A component to perform this function may access a model index. In some embodiments, the model index may have a form analogous to a page index used by a search engine. In this way, existing techniques optimized for high speed search may also be used to quickly select and apply a model. Such an approach may be useful in scenarios in which a model is identified based on terms or other aspects of a search query. Further, in some embodiments, the models may be treated as web pages and may include meta tags to aid in indexing them in a search engine.

To facilitate the use of models, each model may be represented as a collection of declarative statements (“expressions”).

An expression is a symbolic representation of a computation to be performed, which may comprise operators and operands. The operators of an expression may include any operators known to one of skill in the art (such as the common mathematical operators of addition, subtraction, multiplication, and division), any functions known to one of skill in the art, and functions defined by a user. The operands of an expression may include data (such as numbers or strings), symbols that represent data, and other expressions. An expression may thus be recursive in that an expression may be defined by other expressions.

A symbol may represent any type of data used in common programming languages or known to one of skill in the art. For example, a symbol may represent an integer, a rational number, a string, a Boolean, a sequence of data (potentially infinite), a tuple, or a record. In some embodiments, a symbol may also represent irrational numbers, while in other embodiments, symbols may not be able to represent irrational numbers.

For example, an expression may take the form of a symbolic representation of an algebraic expression, such at x²+2xy+y², where x and y may be symbols that represent data or other expressions. An expression may take the form of an equation, such as E=mc², where E, m, and c may by symbols representing data or other expressions. An expression may take the form of a function definition, such as ƒ(x)=x²−1, where ƒ is a symbol representing the function, x is a symbol representing an operand or argument of the function, and x²−1 is an expression that defines the function. An expression may also take the form of a function invocation, such as ƒ(3), which indicates that the function ƒ is to be invoked with an argument of 3.

Expressions may be solved by an expression engine to produce a result. For example, where the symbol x (itself an expression) represents the number 3 and the symbol y (also an expression) represents the number 2, the expression x²+2xy+y² may be solved by replacing the symbols with the values the represent, e.g., 2²+2×2×3+3², and then applying the operators to the operands to solve the entire expression as 25. In another example, where m is a symbol representing the number 2 and c is a symbol representing the number 3, the expression E, defined above, may be solved by replacing E with its definition, e.g., mc², replacing the symbols m and c with the values they represent, e.g., 2×3², and applying the operators to the operands to solve the expression as 18.

In evaluating an expression, the expression engine may apply the operators to the operands to the extent that the operators and operands are defined and to the extent that expression engine knows how to apply the operators to the operands. For example, where the symbol x represents the number 3 and the symbol y is not defined, the expression x²+2xy+y² may be solved by replacing the known symbols with the values the represent, e.g., 2²+2×2xy+y², and then applying the operators to the operands to solve the entire expression as 4+4y+y². Where the symbol x represents the number 3 and the symbol y represents the string “hello”, the expression x²+2xy+y² may be solved as 4+4×hello+hello², since the expression engine may not know how to perform arithmetic operations on the string “hello.”

In some embodiments, expressions may be declarative. A declarative expression may indicate a computation to be performed without specifying how to compute it. A declarative expression may be contrasted with an imperative expression, which may provide an algorithm for a desired result.

In some embodiments, expressions may be immutable. An expression is immutable if it cannot be changed. For example, once a definition is given, such as E=mc², the expression E cannot later be given a different definition. One advantage of immutability is that applications defined by immutable expressions may be side-effect free in that the functionality of the application may not be able to be altered by users of the application.

An application may be defined by a set of expressions, aka a model. An application defined by expressions may have input variables and output variables and the relationship between the input variables and the output variables may be defined by the set of expressions that defines the application. The determination of which variables are input variables and which variables are output variables may be determined by the user. In solving for the output variables, the expression engine may produce data (e.g., a number or a string) or may produce an expression of the input variables.

In this way, the models may be relatively easy to produce and apply. Further, by having the models applied in a model engine, an entity providing search services may receive models from third parties and apply them in an environment in which application of the model cannot interfere with operation of the computer equipment that implements the search system. Furthermore, by allowing the contribution and application of models in the search system from third parties, the search system is able to leverage the expertise of subject matter experts who may have specific knowledge pertinent to particular types of searches. A contributed model may be associated in the model index with characteristics of a search query, such as terms that may be used in a search query, so that it may be selected for application as part of generating information returned in response to a user's query having the specific search query terms.

To facilitate the authoring and contribution of models by third parties, the search system may provide an authoring tool with a user interface that allows a model author to create a model. In some embodiments, models are represented in a format that allows a user to simply create or edit a model by entering a set of declarative statements. The declarative statements may be in a format that would not require computer programming expertise in order to author a model. The authoring tool may execute in the search system itself or on a client system.

The search system may also receive user feedback via a user interface. The feedback may be related to the usefulness and/or relevance of a model that was applied by the search system to generate information returned in response to a user query. Such feedback may be provided explicitly, such as via a voting mechanism, or implicitly, such as by monitoring session length or number of clicks made by the user. Based on the received feedback, the search system may alter a context in which a model is selected by updating associations between the model and the characteristics of the search query, such as terms of the user search query. The search system thereby allows for users to assess the relative value of a model to a specific search query, and ensures that models (particularly those contributed by third parties) stay relevant to search results.

As a result, knowledge useful in generating search results may be captured in models and shared across search systems. Further, by allowing the models to be applied in the search stack of a search system, models may perform computations or other operations based on data that is only available within the search system.

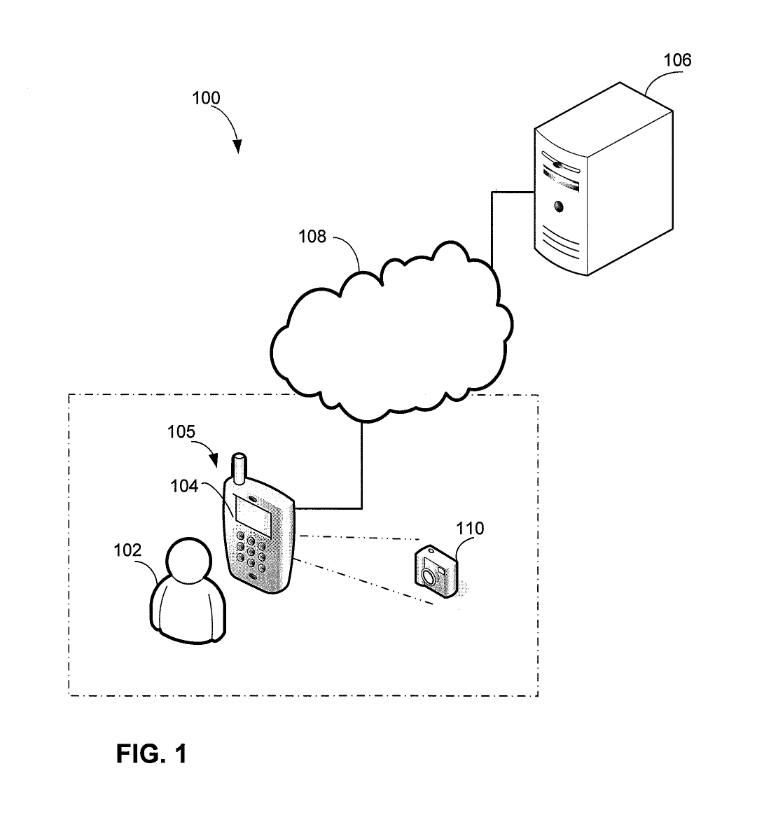

FIG. 1 is a high level diagram illustrating a computing environment 100 in which some embodiments of the invention may be practiced. Computing environment 100 includes a user 102 interacting with a computing device 105. Computing device 105 may be any suitable computing device, such as a desktop computer, a laptop computer, a mobile phone, or a PDA. Computing device 105 may operate under any suitable computing architecture, and include any suitable operating system, such as variants of the WINDOWS® Operating System developed by MICROSOFT® Corporation.

Computing device 105 may have the capability to communicate over any suitable wired or wireless communications medium to a server 106. The communication between computing device 105 and server 106 may be over computer network(s) 108, which may be any suitable number or type of telecommunications networks, such as the Internet, a corporate intranet, or cellular networks. Server 106 may be implemented using any suitable computing architecture, and may configured with any suitable operating system, such as variants of the WINDOWS® Operating System developed by MICROSOFT® Corporation. Moreover, while server 106 is illustrated in FIG. 1 as being a single computer, it may be any suitable number of computers configured to operate as a coherent system.

In the example of FIG. 1, server 106 operates as a search engine, allowing user 102 to retrieve information relevant to a search query. The user may specify the query explicitly, such as by inputting query terms into computing device 105 in any suitable way, such as via a keyboard, key pad, mouse, or voice input. Additionally and/or alternatively, the user may provide an implicit query. For example, computing device 105 may be equipped with (or connected via a wired or wireless connection to) a digital camera 110. An image, such as of an object, a scene, or a barcode scan, taken from digital camera 110 may serve as an implicit query.

Regardless of the type of input provided by user 102 that triggers generation of a query, computing device 105 may send the query to server 106 to obtain information relevant to the query. After retrieving data relevant to the search query, such as, for example, web pages, server 106 may apply one or more declarative models to the data to generate higher level information to be returned to user 102. The information generated by server 106 may be sent over computer network(s) 108 and be displayed on display 104 of computing device 105. Display 104 may be any suitable display, including an LCD or CRT display, and may be either internal or external to computing device 105.

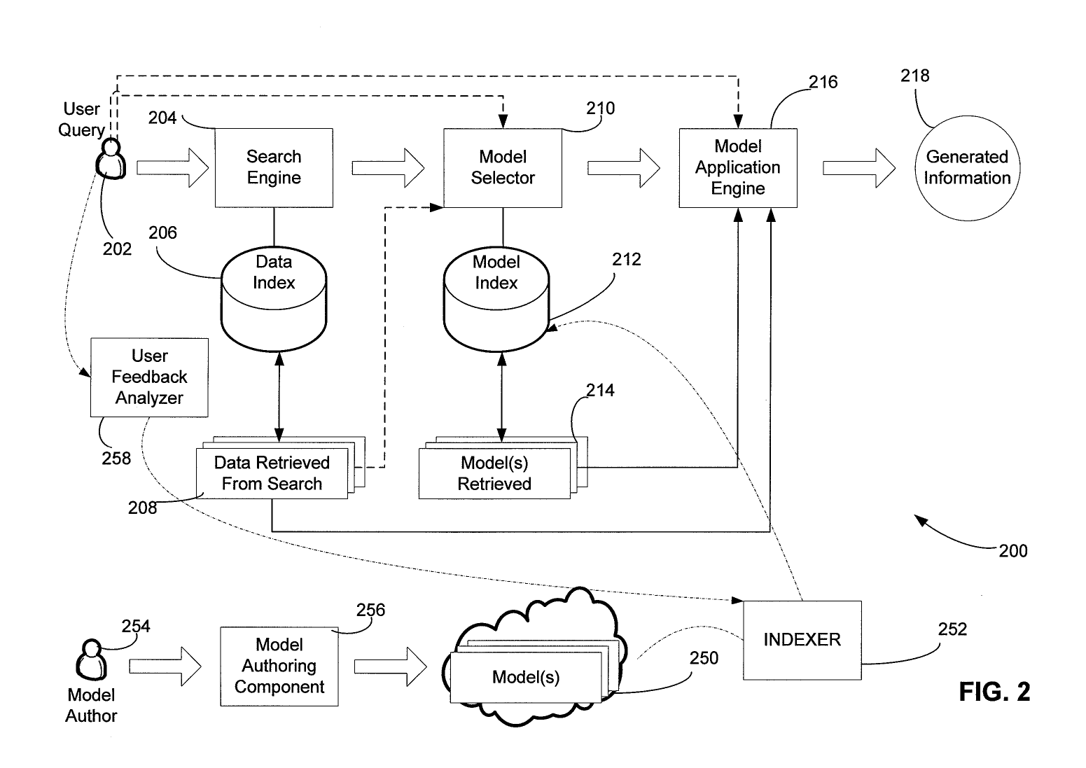

FIG. 2 is an architectural block diagram of a search stack 200 according to some embodiments, such as may be implemented by server 106 of FIG. 1. The components of search stack 200 may be implemented using any suitable configuration and number of computing devices, such as for purposes of load-balancing or redundancy. For example, the functionality described in connection with each component of the search stack may be performed by different physical computers configured to act as a coherent system, and/or a single physical computer may perform the functionality ascribed to multiple components. In addition, in some embodiments, some of the functionality ascribed to a single component of the search stack may be distributed to multiple physical computers, each of which may perform a different portion of the computation in parallel.

Regardless of the specific configuration of search stack 200, a user query 202 may be provided as input to search stack 200 over a computer networking communications medium, and may be either implicit or explicit, as discussed in connection with FIG. 1. In the example of FIG. 2, user query 200 is provided to an input component in search stack 200, such as search engine 204, which may be any suitable search engine, such as the BING® search engine developed by Microsoft Corporation. Search engine 204 may be coupled to one or more storage media comprising a data index 206. Data index 206 may be stored on any suitable storage media, including internal or locally attached media, such as a hard disk, storage connected through a storage area network (SAN), or networked attached storage (NAS). Data index 206 may be in any suitable format, including one or more unstructured text files, or one or more relational databases.

Search engine 204 may consult data index 206 to retrieve data 208 related to the user query 202. The retrieved data 208 may be a data portion of search results that are retrieved based on user query 202 and/or other factors relevant to the search, such as a user profile or user context. That is, data index 206 may comprise a mapping between one or more factors relevant to a search query (e.g., user query terms, user profile, user context) and data, such as data pages, that match and/or relate to that query. The mapping in data index 206 may be implemented using conventional techniques or in any other suitable way.

Regardless of the type of mapping performed using data index 206 to retrieve data 208 relevant to the search, data 208 may comprise any suitable data retrieved by search engine 204 from a large body of data, such as, for example, web pages, medical records, lab test results, financial data, demographic data, video data (e.g., angiograms, ultrasounds), or image data (e.g., x-rays, EKGs, VQ scans, CT scans, or MRI scans). Data 208 may be retrieved or identified dynamically by search engine 204 or it may be cached as the result of a prior search performed by search engine 204 based on similar or identical query. Data 208 may be retrieved using conventional techniques or in any other suitable way.

The search stack 200 may also include a model selection component, such as model selector 210, which may select one or more appropriate declarative model(s) 214 from a set of models stored on one or more computer readable media accessible to the model selector 210. The search stack may then apply the selected model(s) 214 to the results (i.e., data 208) of the search performed by search engine 204, Model selector 210 may be coupled to model index 212, which may be the same as data index 206 or may be a separate index. Model index 212 may be implemented on any suitable storage media, including those described in connection with data index 206, and may be in any suitable format, including those described in connection with data index 206. Model index 212 may comprise a mapping between one or more factors relevant to the user's search (e.g., terms in user query 202, user profile, user context, and/or the data 208 retrieved by the search engine 204) and appropriate model(s) 214 that may be applied to the data 208 retrieved by search engine 204.

Selected models 214 may be selected from a larger pool of models 250 stored on computer-readable media associated with server 106 (FIG. 1). In some embodiments, pool of models 250 may be supplied by an entity operating the search system. Though, in other embodiments, all or a portion of the models in pool of models 250 from which models 214 are selected may be provided by parties other than the entity operating the search system. In some embodiments, models in pool of models 250 may be supplied by a user inputting user query 202. In such a scenario, a portion of pool of models 250 accessed by model selector 210 may include computer storage media segregated to store data personal to individual users, such as the user submitting user query 202. In other embodiments, a community of users may have access to the search system and pool of models 250 may include models submitted by users other than the user who submitted user query 202. In yet other embodiments, some or all of the models in pool of models 250 from which models 214 were selected may be provided by other third parties, for example, model author 254. Such third parties may include businesses or organizations that have a specialized desire or ability to specify the nature of information to be generated in response to a search query. For example, a model that computes commuting distance from a house for sale may be provided by a real estate agent. A model that computes comparative lab results may be provided by a medical association. Accordingly, it should be appreciated that any number or type of models may be incorporated in pool of models 250.

The models authored by third parties may be provided to the search stack for use in processing search queries. To author a model, a third party may use an authoring component, such as authoring component 256. Authoring component 256 may include an authoring tool that allows model author 254 to use a user interface that is part of the tool to specify information to be included in the model.

The authoring tool may be implemented and made available for use by users or other third parties in any suitable way. For example, it may be an executable program available for download and installation on a computing device operated by model author 254, or it may be an application that is executed on a server (which may or may not be part of the search stack) and is displayed to model author 254 in a web browser.

The user interface of authoring component 256 and the underlying specification of a model may be designed in such a way that a user who is not familiar with computer programming may readily author a model. For example, the user interface may receive user input defining a specification for the model. The user input may be in the form of declarative statements, such as expressions including constraints, equations, calculations, rules, and/or inequalities. Based on interactions of model author 254 with the user interface, the authoring tool may generate a model in a particular format, such as any suitable file format (e.g., text file, binary file, web page, XML, etc.). In one embodiment, declarative statements entered by the user to comprise a specification for the model are stored in a text file format, such as XML.

In embodiments in which authoring component 256 is executing as part of search stack 200 (such as if it is executing on a computing device operated by model author 254), model author 254 may provide the model created using authoring component 256 to the information retrieval system. The information retrieval system may then store the provided model into pool of models 250. If the model provided by model author 254 is not in a suitable format, authoring component 256 may first convert the provided model into the appropriate format.

In some embodiments, to facilitate easy addition of models to pool of models 250, the search system illustrated in FIG. 2 may include an indexer 252. Indexer 252 may update model index 212 based on models contained within pool of models 250, including models provided by third parties. In some embodiments, each of the models in pool of models 250 may contain meta tags identifying context in which the model may be applied. Indexer 252 may use this information similar to meta tags attached to web pages to construct model index 212. In this regard, indexer 252 may be implemented using technology known in the art for implementing a web crawler to build a page index. To support such an implementation, each of the models in pool of models 250 may be formatted as a web page. However, it should be recognized that any suitable technique may be used for constructing model index 212, including machine learning techniques or explicit human input. Model selector 210 may be implemented using technology known in the art for implementing a search engine based upon an index. However, rather than identifying which pages to return to a user based on a data index, model selector 210 may employ model index 212 to identify models used in generating information to provide to a user. Model selector 210 may identify models based on a comparison (e.g., precise match) between factors relevant to the search and terms in the model index. Though, besides performing a precise match, inexact matching techniques may alternatively or additionally be used as a basis of the comparison. In some embodiments, the declarative models are themselves stored in model index 212, while in other embodiments, the models themselves may be stored separately from model index 212, but in such a way that they may be appropriately identified in model index 212.

Search stack 200 may also include a model application engine 216, which may apply the selected model(s) 214 to the data 208 retrieved by search engine 204. In the application of a model, data 208 may serve as a parameter over which the selected model(s) is applied by model application engine 216. Additional parameters, such as portions of user query 202, may also be provided as input to the selected model(s) during model application. Though, it should be appreciated that any data available within the search environment illustrated in FIG. 2 may be identified in a model or used by model application engine 216 when the model is applied.

As a result of the application of the model to the search results performed by model application engine 216, information 218 may be generated. Generated information 218 may be returned to the user by an output component (not shown) of search stack 200. Though, the generated information may be used in any suitable way, including as a query for further searching by search engine 204. Generated information 218 may include the results of model application performed by model application engine 216, may include data 208 retrieved by the search engine 204, or any suitable combination thereof. For example, based on the application of a model performed by the model application engine 216, the ordering of the presentation to a user of data 208 may change, the content presented as part of data 208 may be modified so that it includes additional or alternative content that is the result of a computation performed by model application engine 216, or any suitable combination of the two. Thus, when selected model(s) 214 are applied to raw data, such as data 208, retrieved by a search engine, the generated information 218 may be at a higher level of abstraction and therefore be more useful to a user than the raw data itself.

After having received generated information 218 in response to the search query, a user may provide feedback to search stack 200 related to the usefulness of a model that was applied as part of the production of generated information 218. Accordingly, search stack 200 may also include user feedback analyzer 258, which may receive such user feedback and analyze it. The result of the analysis performed by feedback analyzer 258 may be used to update model index 212, for example, to favor or disfavor a model associated with particular search terms based on the analysis of user feedback. Thus, updates to model index 212 based on user feedback may influence which model(s) is selected by model selector 210 and applied to generate information returned in response to a search query. Model index 212 may be updated in any suitable way based on the analysis performed by feedback analyzer 258. For example, feedback analyzer 258 may update model index 212 directly, or it may convey the appropriate information to indexer 252, which may itself update model index 212 on behalf of feedback analyzer 258.

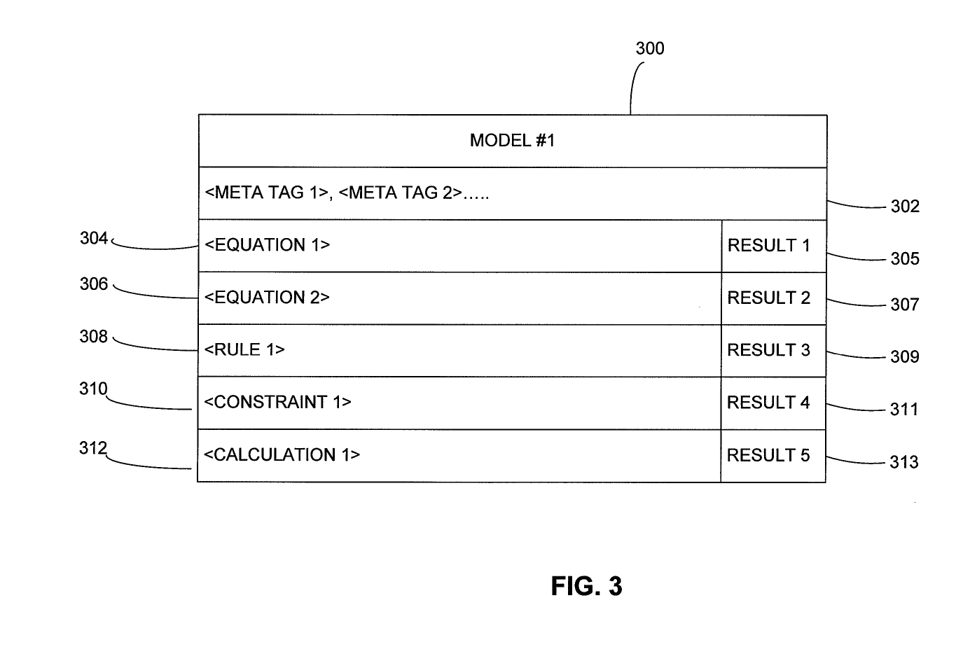

FIG. 3 is a sketch of a data structure string of a declarative model 300, such as one of model(s) 214 selected by model selector 210 of FIG. 2. Model 300 may be stored in any suitable way. In some embodiments, it may be stored in a file, and may be treated as a web page. Accordingly, in such embodiments, like other web pages, model 300 may include meta tags 302 to aid in indexing the model, such as in model index 212 of FIG. 2, thus relating the model to factors such as a query that are relevant to a search.

Model 300 may comprise one or more elements, which in the embodiment illustrated are statements in a declarative language. In some embodiments, the declarative language may be at a level that a human being who is not a computer programmer could understand and author. For example, it may contain statements of equations and the form of a result based on evaluation of the equation, such as equation 304 and result 305, and equation 306 and result 307. An equation may be a symbolic or mathematical computation over a set of input data.

Model 300 may also comprise statement(s) of one or more rules, such as rule 308 and the form of a result based on evaluation of the equation, such as rule result 309. The application of some types of rules may trigger a search to be performed, thereby collecting new information. According to some embodiments, when a model such as model 300 containing a rule, such as rule 308, is applied, such as by model application engine 216, the evaluation of the rule performed as part of the application of the model may generate a search query and trigger a search to be performed by the data search engine, such as search engine 204. Thus, in such embodiments, an Internet search may be triggered based on a search query generated by the application of a model to the search data. Though a rule may specify any suitable result. For example, a rule may be a conditional statement and a result that applies, depending on whether the condition evaluated dynamically is true or false. Accordingly, the result portion of a rule may specify actions to be conditionally performed or information to be returned or any other type of information.

Model 300 may also comprise statement(s) of one or more constraints, such as constraint 310 and result 311. A constraint may define a restriction that is applied to one or more values produced on application of the model. An example of a constraint may be an inequality statement such as an indication that the result of applying a model to data 208 retrieved from a search be greater than a defined value.

Model 300 may also include statements of one or more calculations to be performed over input data, such as calculation 312. Each calculation may also have an associated result, such as result 313. In this example, the result may label the result of the specified calculation 312 such that it may be referenced in other statements within model 300 or otherwise specifying how the result of the computation may be further applied in generating information to a user. Calculation 312 may be an expression representing a numerical calculation with a numerical value as a result, or any other suitable type of calculation, such as symbolic calculations. In applying model 300 to data 208 retrieved by a search engine, model application engine 216 may perform any calculations over data 208 that are specified in the model specification, including attempting to solve equations, inequalities and constraints over the data 208. In some embodiments, the statements representing equations, rules, constraints or calculations within a model may be interrelated, such that information generated as a result of one statement may be referenced in another statement within model 300. In such a scenario, applying model 300 may entail determining an order in which the statements are evaluated such that all statements may be consistently applied. In some embodiments, applying a model may entail multiple iterations during which only those statements for which values of all parameters in the statement are available are applied. As application of some statements generates values used to apply other statements, those other statements may be evaluated in successive iterations. If application of a statement in an iteration changes the value of a parameter used in applying another statement, the other statement will again be applied based on the changed values of the parameters on which it relies. Application of the statements in a model may continue iteratively in this fashion until a consistent result of applying all statements in the model occurs from one iteration to the next, achieving a stable and consistent result. Though, it should be recognized that any suitable technique may be used to apply a model 300.

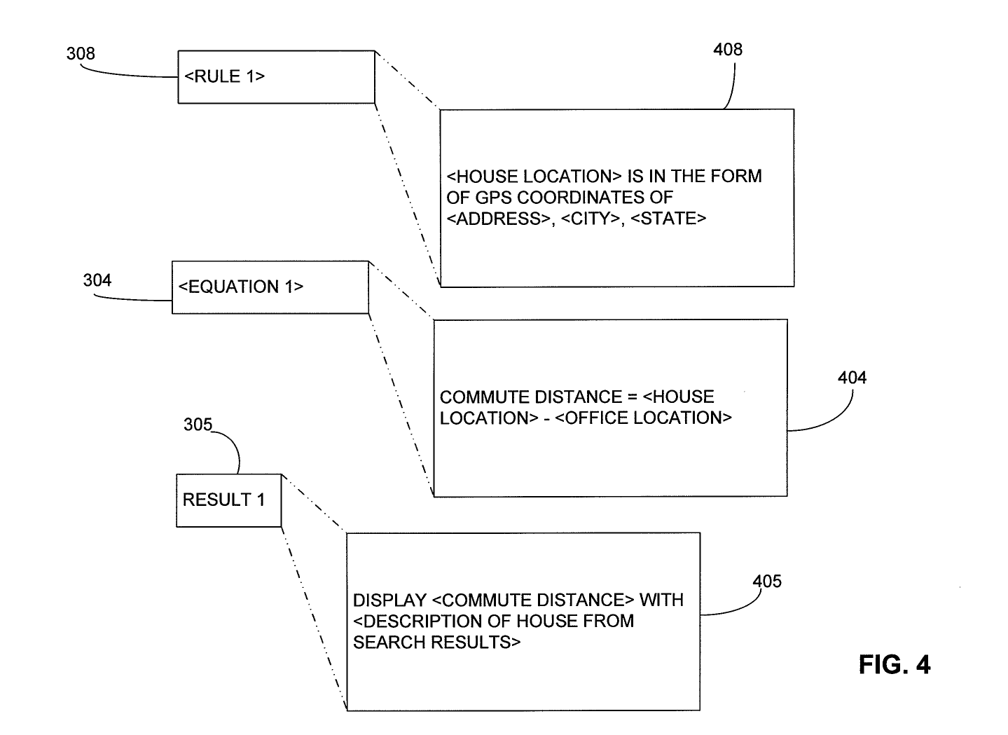

FIG. 4 provides an example of statements such as those that may be specified for model 300. In the example of FIG. 4, the model may be selected and applied when a user is performing a house search, and may in this example, relate houses for sale to the user's commute. Application of the model in the example of FIG. 4 may generate information on the commuting distance and/or time between each house for sale and the user's office location. Thus, rule statement 408 is an example of rule 308 from FIG. 3 that specifies the form of a house location to be used as part of the model computations. In this example, rule statement 408 specifies that a parameter, identified as a house location, be in the form of global positioning system (GPS) coordinates of the address, city and state of the house for sale. These parameters may, when the model is applied, be given values by model application engine 216 based on retrieved data 208. In this example, rule 308 may evaluate to true when a web page, or other item of retrieved data, contains information that is recognized as a house location by application of rule 308. Accordingly, rule 308 may be used to identify items of data for which other statements within the model are applied.

Equation statement 404 is an example of equation 304 of FIG. 3 that provides a computation to be performed to arrive at the commute distance, based on the location of the house for sale as specified in rule statement 408 and a value that may be available to model application engine 216, which in this example is indicated as the office location. In this example, the office location is an input parameter to the model that may have been provided, for example, as part of the user query, as part of the user's profile or user context. The house location, however, is based on the application of rule statement 408, received from another input to the model, such as data 208 that are returned as the result of the search engine.

Result statement 405 is an example of result 305 of FIG. 3 that specifies how to display the result of the computation performed for equation statement 404. Thus, result statement 405, in this example, specifies that the commute distance to each house for sale from the search results be displayed alongside the description of the house, which is a parameter for which a value may be established based on data 208.

The example of FIG. 4 illustrates some of the statements that may be present in a model to display results to a user query. In this example, the results relate to houses for sale. Accordingly, the model depicted in FIG. 4 may be selected by model selector 210 (FIG. 2) in response to a user query 202 requesting information on houses for sale. The model may be applied by model application engine 216 to every item of data in retrieved data 208. Though, not every retrieved item of data may comply with rule 308 or other conditions established by statements within the model. Accordingly, not every item of retrieved data 208 may be included in generated information 218. Though, FIG. 4 illustrates that other information, not expressly included within retrieved data 208, may be included in generated information 218. In the simple example of FIG. 4, a value of a parameter called “commute distance” is computed by model application engine 216 upon application of the model of FIG. 4.

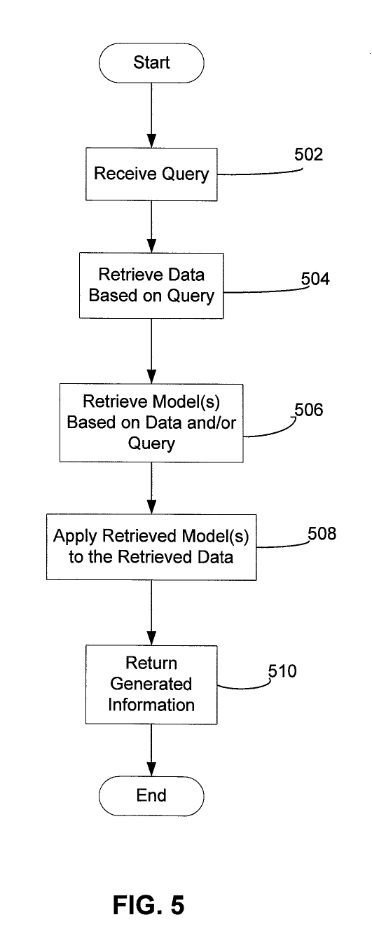

FIG. 5 is a flowchart of a process that may be performed during execution by a search stack, such as search stack 200 of FIG. 2 according to some embodiments. The process may start when a computing device, such as computing device 105 of FIG. 1, sends a search query on behalf of a user to a search engine, such as search engine 204 of FIG. 2. Though, it is not a requirement that the search process be triggered by express user input or express user input in textual form. Non-textual inputs or implied user inputs may be regarded as a query triggering execution of the process of FIG. 5.

In step 502, the search stack may receive the user's query. As discussed above, a user's query may be either implicit or explicit. For example, in some embodiments, a search stack may generate a search query on behalf of the user. The search stack, for example, may generate a search query based on context information associated with the user. This may be performed for example, by search engine 204 of FIG. 2.

Regardless of how the query is generated, in step 504, the search engine may then retrieve data matching the search results query. The data returned may be based on a match (whether explicit or implicit) between the query (and/or other factors, such as user context and a user profile) and terms in an index accessible to the search engine, such as data index 206 of FIG. 2.

The process then flows to step 506, in which the search stack may retrieve one or more models appropriate to the user's search. In the exemplary implementation of FIG. 2, appropriate model(s) may be selected by the model selector 210 in connection with an index (e.g., model index 212) relating a user's query and/or data returned by the search engine to one or more appropriate model(s).

At step 508, the search stack may then apply the retrieved model(s) to the retrieved data. In the exemplary implementation of FIG. 2, this step may be performed by model application engine 216. In addition to the retrieved data itself, other factors relating to the search such as the user query (or one or more portions thereof) may also serve as input to one or more computations performed as a result of applying the model on the retrieved data. Processing at step 508 may entail multiple iterations. In some embodiments, a model may apply to each item of data, such as a web page included in retrieved data 208. Accordingly, processing at step 508 may be iterative in the sense that it is repeated for each item contained within retrieved data 208. Alternatively or additionally, processing at step 508 may be iterative in that application of a model, whether applied to an individual item of data or a collection of items of data, may entail iteratively applying statements in the model until a stable and consistent result is achieved. Processing at step 508 may alternatively or additionally be iterative in the sense that multiple models may be selected by model selector 210 such that information in compliance with each of the selected models may be generated by processing at step 508.

Turning to step 510, the search stack may then output results generated as a result of the application of the selected model(s) to the retrieved data. In this example the output may entail returning information to a user computer which can then render the information on a display for a user. In some embodiments, the generated information may include some combination of the result of applying the model on the data returned from the search engine and the data itself. For example, the generated information may filter or reorder the search data based on the application of the model, or may provide additional information or information in a different format than the data returned by the search results. In some embodiments, the reordering of the search data may incorporate a time element. For example, a model may identify a time order of a set of multiple events. Application of such a model may then entail identifying search data related to those events, and generating the information returned to the user in an order in accordance to the time order of the model. Though, it should be recognized that the nature of the information generated may be in any suitable form that can be specified as a result of application of a model, which may contain a combination of elements, such as calculations, equations, constraints and/or rules.

After the data is returned to the user (via the user's computing device), the process of FIG. 5 may be done.

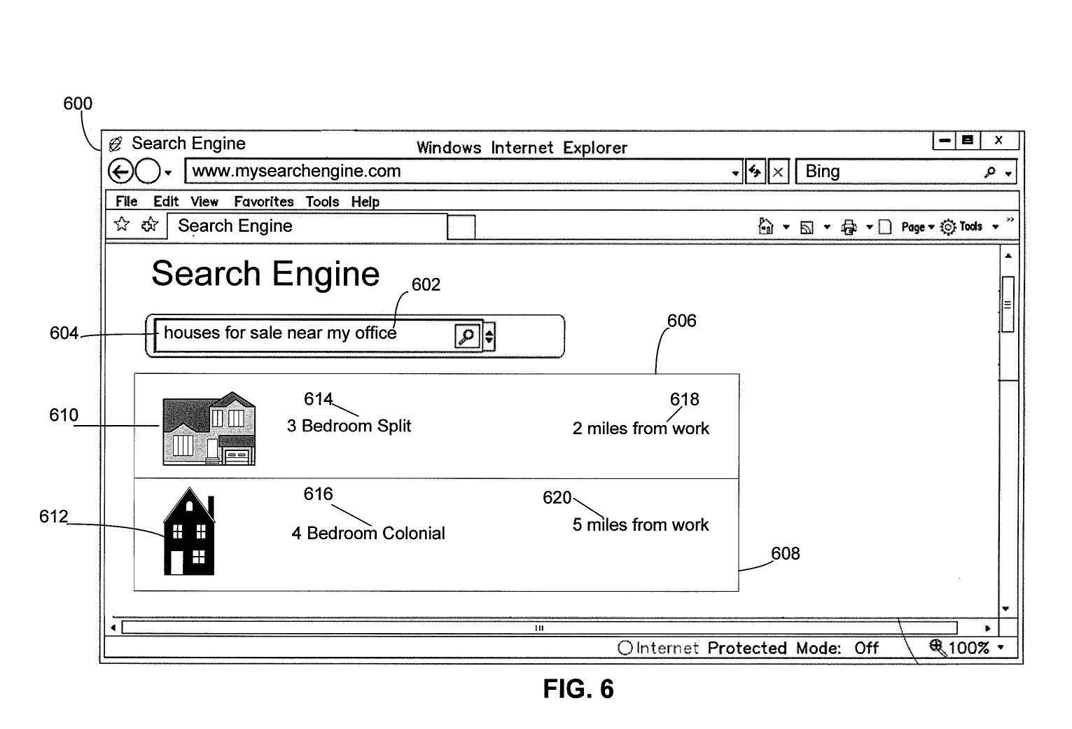

FIG. 6 is an example of a user interface via which a user may access a search in a retrieved system. In this example, a user may enter a search query and view information returned in response to the query. FIG. 6 illustrates that the interface is displayed by a web browser 600, although any suitable application to generate a user interface may be used. The web browser 600 may be any suitable web browser, illustrated in this example as being INTERNET EXPLORER® developed by Microsoft Corporation, and may execute on a computing device operated by the user (such as computing device 105 of FIG. 1). In the example of FIG. 6, the web browser has loaded a web page returned by a search and retrieval system such as that illustrated in FIG. 2.

The user has entered a text query 604, “houses for sale near my office,” in a query input field 602 in the user interface, and sent that query via web browser 600 to a search engine that is part of a search stack according to some embodiments. In response, the search stack returned generated information to the user via the web browser, illustrated in FIG. 6 as returned information elements 606 and 608, which are displayed in the web browser.

After receiving the user's query, the search engine may retrieve a set of data (e.g., web pages) including results of houses for sale near the user's office. The set of data returned from the search engine may be based on matches between the query terms and terms in an index relating to the web pages, as discussed above. Though, as illustrated, other sources of data may be used in evaluating the search query. In this example, the search query includes the phrase “my office.” That phrase may be associated with information in a user profile accessible to the search and retrieval system processing the query. Accordingly, on execution of the query, the search and retrieval system may filter results based on geographic location in accordance with the information specified in the user profile. Though, it should be recognized that any suitable technique may be used to process a search query and retrieve data.

Based on the query and/or the retrieved data, an appropriate model may then be selected by the search stack, such as by model selector 210 of FIG. 2. In the example of FIG. 6, the model specified in FIG. 4 relating houses for sale to a user's commute is selected based on the portion of the query text, “near my office.”

The selected model is then retrieved and applied to the data (i.e., the web pages of houses for sale) resulting from the search. The application of the model to the data may be performed, for example, by model application engine 216. In the example of FIG. 6, the user's office location may also be a value of an input parameter to the selected model. Because the query text “near my office” does not specify the exact office location, in this example, the user's office location may be taken from the user's profile or the user's context, for example. In this example, as discussed in connection with FIG. 4, applying the selected model comprises determining the GPS coordinates of the address, city and state of each house for sale from the search results, computing the commuting distance between each house and the user's office, and arranging the generated information to display the commuting distance alongside the description of each house for sale. In the example of FIG. 6, the display of the generated information has also been sorted based on commuting distance.

Thus, in the example of FIG. 6, two listings of houses for sale are returned by the search stack and displayed in the web browser, returned information elements 606 and 608. Each of returned information 606 and 608 includes a picture 610 and 612, respectively, of the house for sale and a description 614, and 616, respectively, of the house for sale. In addition, returned information elements 606 includes commuting information 618, “2 miles from work,” displayed alongside description 614, and returned information 608 includes commuting information 620, “5 miles from work,” displayed alongside description 616. In the example of FIG. 6, returned information elements 606 and 608 are returned as being sorted in ascending order based on commuting distance.

Accordingly, as the result of the application of the model specified by the example of FIG. 4, more useful information is returned to the user. That is, instead of merely returning a list of houses for sale, based on additional dynamic computations performed that are specific to the user or his query (i.e., based on his office location), performed based or dynamically identified data (houses for sale in this example), additional information (i.e., commute information) may be provided to the user than would otherwise be possible, and the results may be arranged accordingly. Accordingly, applying the selected model has allowed the user to receive additional information and presented in a manner that is more pertinent to his search query.

Model(s) applied to a search query may have been created by an operator of the search stack or they may have been provided by third parties, as discussed above. Such third parties may include businesses, organizations or individuals that have a specialized desire or ability to specify the nature of information to be generated in response to a search query. In the case of a model that computes commuting distance from a house for sale, such as the model specified by the example of FIG. 4, the model may have been provided by a real estate agent. As another example, a model that computes comparative lab results may be provided by a medical association. As yet another example, a camera enthusiast or a camera retailer may provide a model that performs calculations involving specifications of the camera (e.g., optical zoom level, weight, or megapixel range) that could be applied to a suitable query, such as, “camera for light travel.” As a fourth example, a fashion designer may provide a model with aesthetics logic that can rank and cluster clothes and accessories (e.g., according to style, color, cut, occasion) within search results. A weather scientist, as a fifth example, may provide a model to project the weather for a particular location (e.g., to project snow conditions over the next seven days for a micro-climate in the Cascades using a polynomial that is curve-fitted to the scientist's local observations), which may be applied in response to a suitable query in which the application of the model may be valuable (e.g., “skiing conditions in Cascades”). As yet another example, a dietician or health organization may provide a model that calculates information pertaining to a particular diet (e.g., recommended daily allowance (RDA)) about a food item, so that when a user searches for food recipes, for example, the model may be triggered and calculate the percentage of RDA of fat or carbohydrates that is in one serving of the recipe.

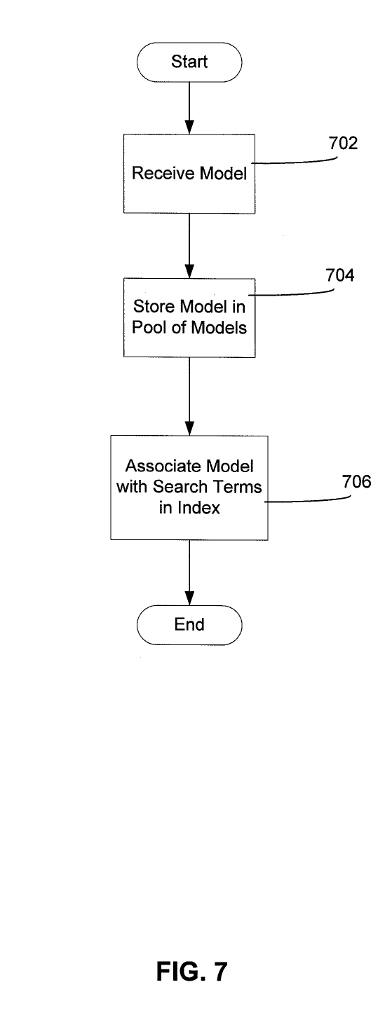

FIG. 7 is a flowchart illustrating a process of receiving a model from a third party and incorporating that model into a search stack infrastructure. The process of FIG. 7 may be performed by a search stack, such as search stack 200 of FIG. 2. The process starts at step 702, when the search stack receives a model from a third party (e.g., model author 254 of FIG. 2). Step 702 may involve authoring a model based on interactions between a user interface included in a model authoring tool and between model author 254. As discussed in connection with FIG. 2, a model received by a search stack may have been generated using an authoring tool executing outside the search stack (e.g., on a computing device operated by model author 254 or on a computing entity separate from the search stack but operated by the same entity as the search stack) and provided to search stack 200, or it may have been generated using an authoring tool executing in the search stack itself.

Regardless of the specific way in which the model is generated based on user input and received by the search stack, at step 704, the received model may be stored in a pool of models, such as pool of models 250, that are available to be applied to search results. In some embodiments, search stack 200 may first translate the received model to a suitable format prior to storing the model in the pool of models.

At step 706, the received model may be associated with factors relating to a search (e.g., search terms, user context, user profile, etc.) that may trigger application of the model to search results. In the example of FIG. 2, this step may be performed by indexer 252, which may update model index 212 according to the association. The association between factors relating to a search query and the search terms may be made in any suitable way. For example, as discussed above, the association may be made based on meta tags included in the model specification. These meta tags may have been specified by the model author explicitly or they may have been generated automatically by authoring component 256 based on other information specified in the model.

It is to be appreciated that in some embodiments, steps 704 and 706 could alternatively and/or additionally be performed in reverse order or in parallel. Once the model is stored and indexed appropriately, the process of FIG. 7 may be done, as the model is then available to be applied to a user's search results.

The search stack may also be configured to modify the index of models, such as model index 212 of FIG. 2, based on user feedback. Though FIG. 2 illustrates indexer 252 updating model index 212 by “crawling” a pool of models 250, indexer 252 may be adapted to update model index 212 using alternative or additional techniques. For example, based on user feedback that a first model may be more useful than a second model for a particular type of query, the model index may be modified to favor selection of the first model over the second model for that particular query. The user feedback may be either explicit, such as via an explicit voting mechanism, or implicit, such as may be obtained by tracking an indicator of the behavior of a user interacting with the generated information returned as a result of applying a particular model (e.g., monitoring session length, number of user clicks on a model or on results returned by a model, or page exit paths). For example, if a user mouse clicks on the first piece of generated information returned to the user, and does not click on any other links for a specified period of time, this series of inputs may be taken as an indication that the first piece was of sufficient interest to the user that he spent a significant amount of time reviewing the information.

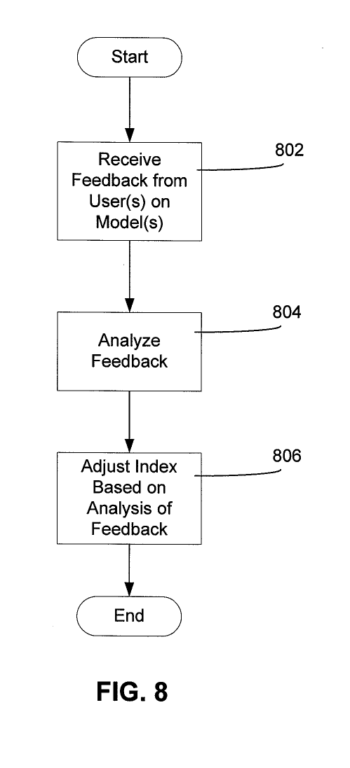

FIG. 8 is a flowchart of a process for updating the association between characteristics of a search query and a model, based on user feedback. FIG. 8 may be performed by any suitable component(s) within search stack 200, as illustrated in FIG. 2, such as feedback analyzer 258. The process of FIG. 8 may begin at step 802, in which feedback analyzer 258 may receive user feedback related to one or more model(s) that were applied to search results as part of producing information generated to the user. The received feedback may be either explicit or implicit, as discussed above.

At step 804, the search stack may then analyze the received feedback on the model(s). The analysis may be performed, for example, by feedback analyzer 258. Any suitable analysis may be performed. For example, analysis may be performed on feedback aggregated across many different users, or it may be performed in the context of a single user. When performed in a single user context, the analysis may include aggregating the received user feedback with previously received feedback on other models, and storing information in a user profile that may be used to infer appropriate models to select and apply as part of the process of returning generated information in response to future user queries.

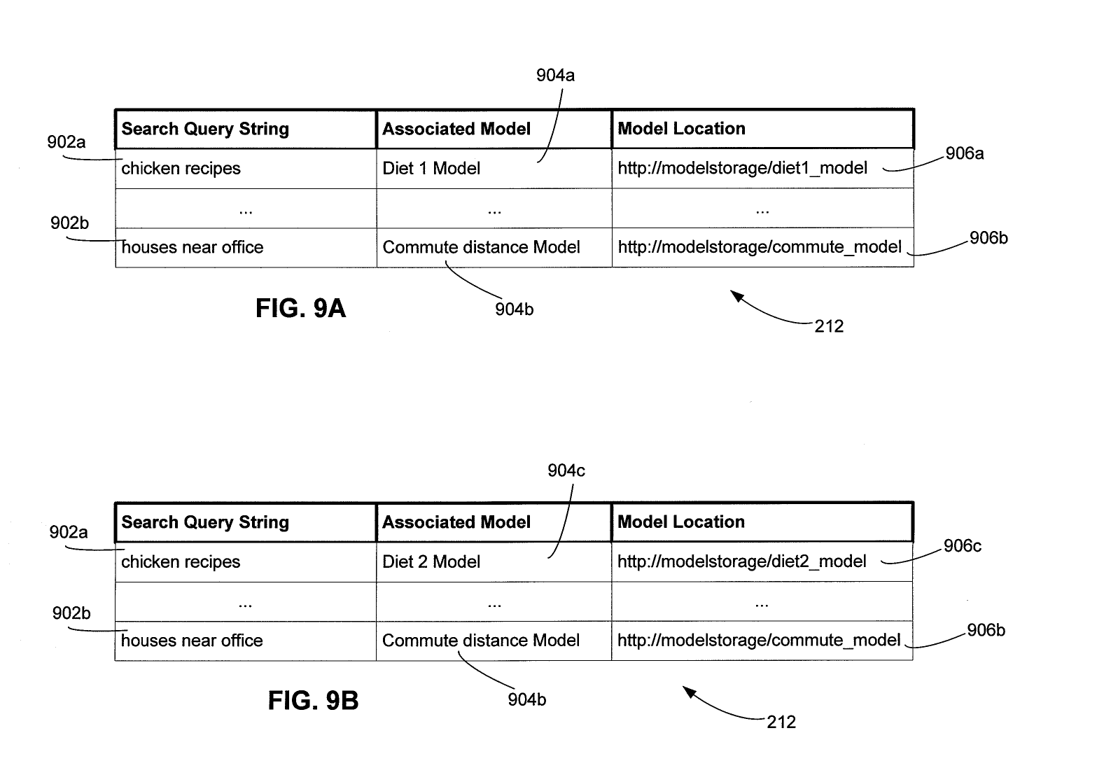

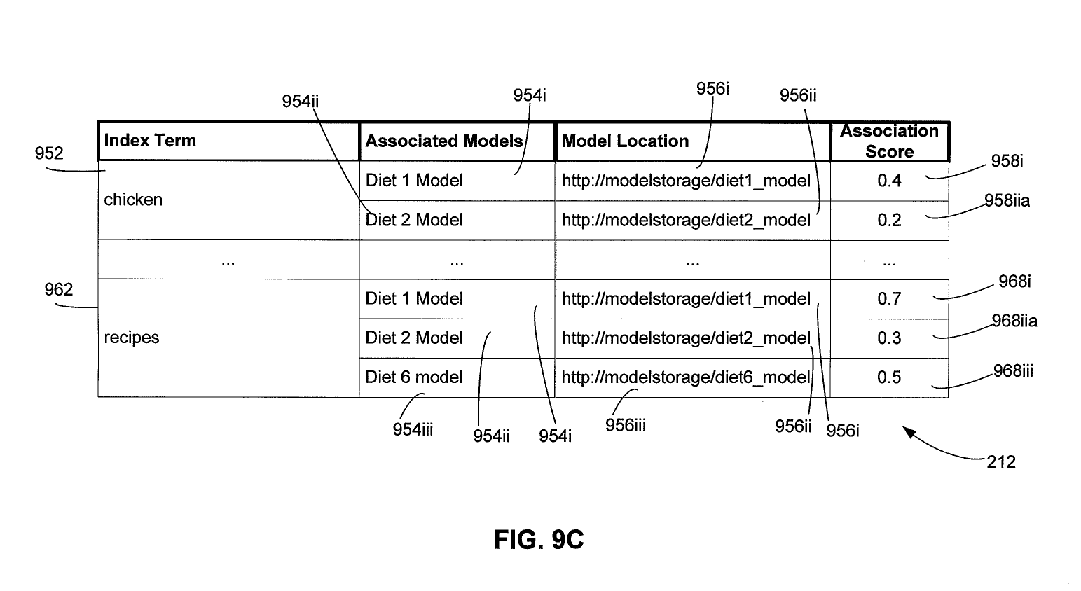

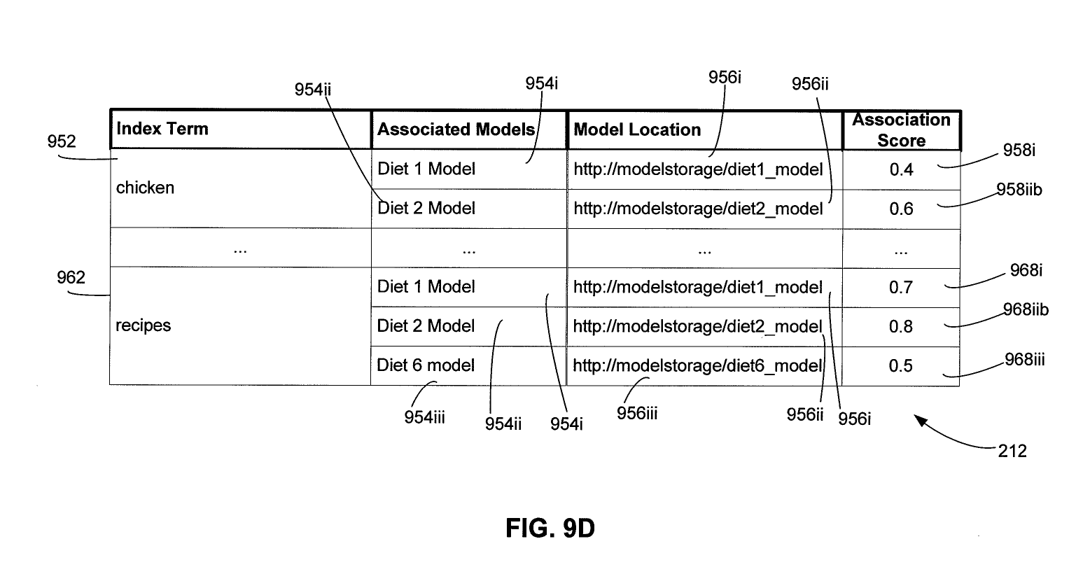

At step 806, the search stack may then adjust the association between the model for which the user provided feedback and factors related to a search (e.g., search query, user context, user profile, data retrieved from the search). In some embodiments such as that illustrated in FIG. 2, an index (e.g., model index 212) may provide such an association between factors related to a search and a model to be selected and applied to search data. In such embodiments, the search stack at step 806 may update the model index based on the analyzed feedback. The index may be updated based on the analyzed feedback in any suitable way, as discussed at greater length below in connection with FIGS. 9A-9D. As a specific example, the updating of the model index may cause a different model to be selected for application to results generated by the same search query. After the index has been updated, the process of FIG. 8 may be complete, as the application of models to future search queries entered by a user reflect the updated information in the model index.

FIGS. 9A and 9B are block diagrams of a first embodiment of model index 212, before and after, respectively, model index 212 has been updated based on the analyzed user feedback. Model index 212 in FIG. 9A stores a plurality of characteristics of a search query. Characteristics of a search query may include, for example, query terms, user context, user profile, or a characterization of a data portion of search results returned in response to a query. The example of FIGS. 9A and 9B, stores search query strings 902a and 902b that each may be associated with one or more models. In this example, search query string 902a is, “chicken recipes,” while search query string 902b is, “houses near my office.” Each of search query strings 902a and 902b is associated with one or more models. For example, search query string 902a is associated with model 904a, which in this example computes nutrition information related to a first diet (“Diet 1 Model”), and search query string 902b is associated with model 904b, which in this example, computes commuting distance between houses for sale and the user's office (“Commute distance model”). Model index 212 also includes model identification information 906a and 906b for models 904a and 904b, respectively. Model identification information 906a and 906b may be used by components of search stack 200, such as model selector 210, in identifying the location of a model in order to retrieve the model, for example. While in the example of FIG. 9A, model identification information is specified as a Uniform Resource Locator (URL), a model may be identified in any suitable way, including by a file path in a file system hierarchy, a database identifier and database query string, etc.

FIG. 9B is a block diagram of the first embodiment of model index 212, as illustrated in FIG. 9A, after model index 212 has been updated based on analyzed user feedback. In the example of FIG. 9B, based on an analysis of user feedback, it is determined that “Diet 1 Model” is no longer the preferred model to be applied when a user enters the query string, “chicken recipes,” and that “Diet 2 Model,” which has different nutritional guidelines than that of “Diet 1 Model” is the new preferred model to be applied for that query string. The determination may be made as the result of any suitable analysis, for example, it may be made based on feedback aggregated across all users who have searched for chicken recipes, in which the majority of users providing feedback indicated that “Diet 2 Model” was preferred for the query string “chicken recipes.”

Accordingly, in the example of FIG. 9B, search query string 902a is now associated with model 904c (“Diet 2 Model”) rather then being associated with model 904a, as before. The identification for the new model (model identification information 906c) has also changed in correspondence with the change in the associated model. Thus, as the result of the update to model index 212 reflected in FIG. 9B, a search for the query string “chicken recipes” would henceforth trigger the application of model 904c to the search results rather than that of model 904a.

It should be appreciated that, while the examples of FIGS. 9A and 9B illustrate a single model at a time as being associated with a search query string, some embodiments may associate a plurality of models with a single search query string. In such embodiments, the plurality of associated models may be ordered or ranked, and be selected for application to search results based on the order in the model index. Accordingly, in such embodiments in which a plurality of models may be associated with a single search query string, modifying the association of search query string 902a to a model may involve changing the first ranked model of the plurality of associated models from being model 904a to model 904c, while model 904a may still be in the plurality models associated with index 902a (albeit at a lower ranking order). In addition, as discussed above, it should be appreciated that an association between models and characteristics of a search query may not be made based on an explicit match (e.g., a match with a user search query, as illustrated in FIGS. 9A and 9B), but may also or alternatively be made based on inexact matching techniques, including probabilistic techniques.

FIGS. 9C and 9D are block diagrams of a second embodiment of model index 212, before and after, respectively, model index 212 has been updated based on the analyzed user feedback. In this second embodiment of model index 212, rather than storing specific possible search queries, as in FIGS. 9A and 9B, model index 212 as illustrated in FIGS. 9C and 9D stores index terms 952 and 962, illustrated as “chicken” and “recipes,” respectively. Thus, a single search query may be comprised of multiple index terms in model index 212. For example, the search query string, “chicken recipes,” is comprised of both index terms 952 and 962.

Each index term may be associated with one or more models. Thus, in this example, index term 952 is associated with models 954i (“Diet 1 Model”) and 954ii (“Diet 2 Model”). Index term 962 is also associated with models 954i and 954ii, and is additionally associated with model 954iii (“Diet 6 Model”). As in the first embodiment illustrated in FIGS. 9A and 9B, model index 212 in the embodiment of FIGS. 9C and 9D may also store an identifier (e.g., a location, etc., as discussed above) for each model. Thus, in this second embodiment, model index 212 stores model identification information 956i, 956ii and 956iii for models 954i, 954ii and 954iii, respectively.

In the embodiment of model index 212 illustrated in FIGS. 9C and 9D, for each index term and associated model, a respective association score may be stored in model index 212 indicating a degree of correlation between the index term and the model. Thus, in FIG. 9C, association scores 958i and 958iia are stored for index term 952 as an indication of the degree of correlation between index term 952 and models 954i and models 954ii, respectively. Similarly, in FIG. 9C, association scores 968i, 968iia and 968iii are stored for index term 962 as an indication of the degree of correlation between index term 952 and models 954i, 954ii and 954iii, respectively.

The association scores may be used in selecting a model to be applied to search results returned in response to a search query. Thus, upon receipt of a search query string, any suitable component of the search stack, such as model selector 210, may compute an aggregate association score for each model associated with terms in the search query string. The aggregate score may be based on any suitable combination of the association scores for the index terms associated with the model. Thus, in the example of FIG. 9C, upon receiving the search query string, “chicken recipes,” model selector 210 may compute an aggregate score for model 954i based on a suitable combination of association scores 958i and 968i. Similarly, it may compute an aggregate score for model 954ii based on a suitable combination of association scores 958iia and 968iia. Because model 954iii is only associated with one term in the search query (i.e., index term 262), a computation of an aggregate score for model 954iii need not be performed, and in some embodiments, association score 968iii may be used as the aggregate association score for model 954iii. Any suitable type of combination of the association scores may be performed, including an average based on the number of terms in the search query, a sum, a product, etc.

In one embodiment, an association score for an index term-model pair is proportional to the degree of correlation between the index term and the model; thus, in this embodiment, a higher association score indicates a greater degree of correlation. Thus, in such embodiments, model selector 210 may select the model having the highest aggregate association score. However, it should be appreciated that other types of correlation may be possible; for example, the association score may be inversely proportional to the degree of correlation between the index term and the model.

FIG. 9D is a block diagram of the second embodiment of model index 212, as illustrated in FIG. 9C, after model index 212 has been updated based on analyzed user feedback. In the example of FIG. 9D, based on an analysis of user feedback, feedback analyzer 258 may determine that users find model 954ii to be particularly useful when it is applied to process the search query, “chicken recipes.” Accordingly, feedback analyzer may determine that it should adjust the association scores for that model to account for the positive user feedback. In the example of FIG. 9D, feedback analyzer has increased the numerical value of association scores stored in connection with index terms comprising the search query, “chicken recipes,” that is with index terms 952 and 962. Thus, each of association scores 958iia and 968iia of FIG. 9C has been increased to result in new association scores 958iib and 968iib having increased numerical values. Increasing the association scores for the index terms associated with model 954ii also increases the likelihood that model selector 210 may select model 954ii as part of processing the search query string, “chicken recipes.”

Although not illustrated in FIGS. 9C and 9D, association scores may also be adjusted to decrease the likelihood that a particular model may be selected to be applied as part of processing a particular search query string. For example, in the embodiment of the model index illustrated in FIGS. 9C and 9D, decreasing the association scores of a model-index term pair may have the effect of decreasing the likelihood that that model may be applied to search query strings including that index term. Such an adjustment may be made for a variety of reasons, for example, based on the receipt of negative user feedback (e.g., feedback that a particular model is not helpful when applied to search query strings having a particular index term), or the scores for a model associated with a particular index term may be decreased as part of the same operation as increasing the score for another model associated with the same index term, based on the receipt of positive user feedback for that other model.

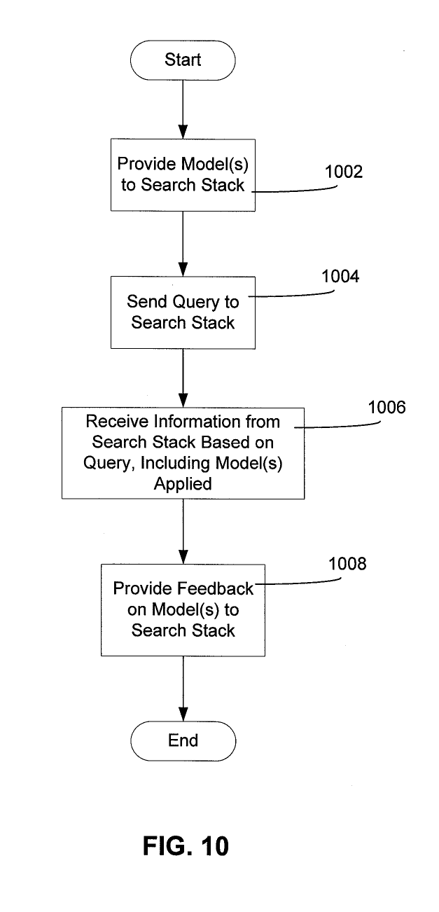

FIG. 10 is a flowchart of a process by which one or more clients of an information retrieval system may provide model(s) and feedback on model(s) to a search stack. The process of FIG. 10 begins at step 1002, in which a model author, such as a third party discussed above, provides a model to the search stack0. The model may be provided in any suitable way, as discussed above. For example, the model may first be authored using an authoring tool executing on a computing device operated by the model author and transmitted over one or more telecommunications networks to the information retrieval system. As another example, the model may be created by the model author using an authoring tool executing in the search stack or on a computer operated by the operator of the search stack. In this instance, the authoring tool may be a web-based interface that may receive user input and generate a model based on the user input. The model provided by the model author may then be stored and indexed appropriately by the search stack, as discussed above.

At step 1004, a search user (which may be the model author or any other user) may submit a query to the search stack in any suitable way, as discussed above.

At step 1006, in response to the query, the search user may receive information generated by the search stack. In some embodiments, the generated information received by the search user may include information indicating which model(s) were applied to generate the information and/or which model(s) are available to be applied to search results generated by such a query.

The search user, at step 1008, may then provide in any suitable way, as discussed above, feedback to the search stack that relates to the usefulness to the search user of the model(s) that were applied to generate the information received by the user in step 1006. The process of FIG. 10 may then be complete.

It should be appreciated that step 1002 may iterate, such that multiple different models may be provided to the search stack by the same model author by or different model author(s). Similarly, steps 1004-1008 may repeat, such that multiple search users (or the same search user) may each issue a query (which may be the same query or different queries) and provide feedback on model(s) that were each applied during the processing of their search query. Thus, the search stack may leverage the expertise of a wide variety of contributors in a wide variety of areas, both in terms of the contribution of a model and in terms of assessing the relevance of a model to a given search query.

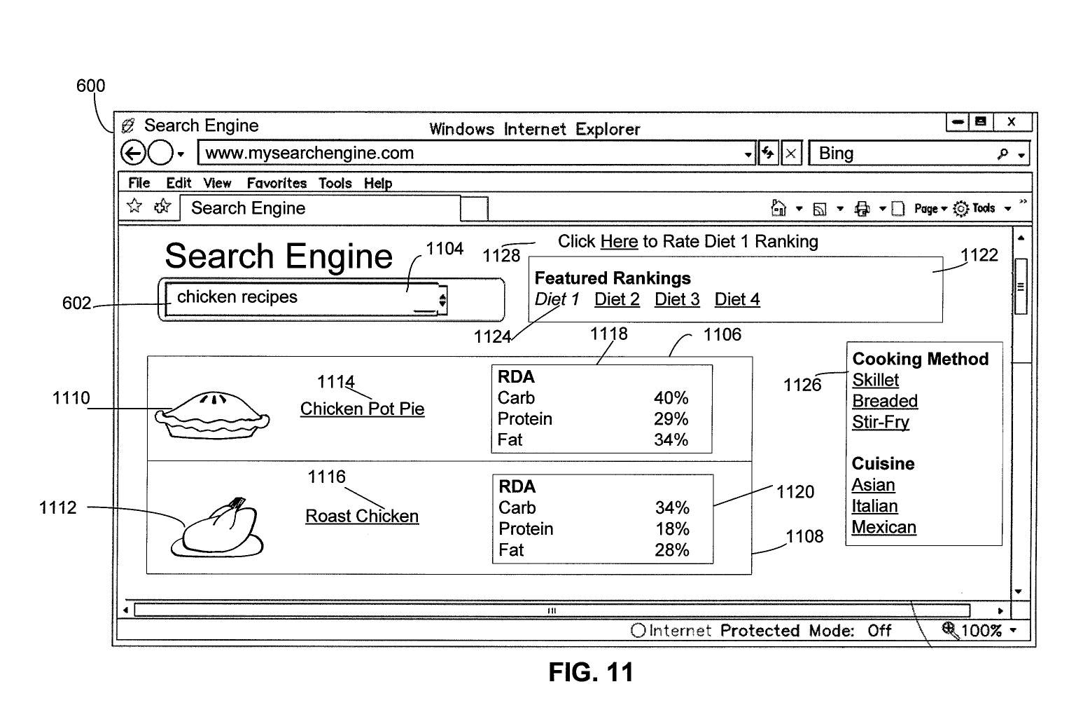

FIG. 11 is an example of a user interface via which a user may provide a search query to a search system, receive information in response to the query, and provide feedback on a model to search results applied as part of processing the query, and thus may be used to perform steps 1004-1008 of FIG. 10. FIG. 11 illustrates that the interface is displayed by a web browser, which may be the same web browser 600 discussed in connection with FIG. 6, although as discussed in connection with FIG. 6, any suitable application to generate a user interface may be used. As in the example of FIG. 6, web browser 600 of FIG. 11 has loaded a web page returned by a search and retrieval system such as that illustrated in FIG. 2.

In the example of FIG. 11, the user has entered a text query 1104, “chicken recipes,” in a query input field 602 in the user interface, and sent that query via web browser 600 to a search engine that is part of a search stack according to some embodiments. In response, the search stack returned generated information to the user via the web browser, illustrated in FIG. 11 as returned information elements 1106 and 1108, which are displayed in the web browser.

As part of processing the text query, “chicken recipes,” in this example, the search stack according to some embodiments identified multiple models as being associated with text query 1104, such as diet models 1122, and included identifiers for each of the associated models as part of the information returned to the user in response to text query 1104. Thus, each of diet models 1122 is displayed in the user interface of FIG. 11. Each of diet models 1122 (e.g., “Diet 1,” “Diet 2,” “Diet 3,” “Diet 4”) specifies computations to be performed by the search stack relating to specific dietary guidelines, and each is displayed in the user interface. However, in this example, only one of the associated diet models 1122, selected diet model 1124 (i.e., “Diet 1”), was applied by the search stack to search results returned in response to text query 1104. Selected diet model 1124 may have been explicitly selected by the user, or it may have been selected automatically by the search stack, such as by model selector 210, as discussed above. Selected diet model 1124 may be indicated to the user as being the selected model. This indication may be done in any suitable way, for example, by using a particular font style (e.g., italics, as in FIG. 11).

However, it should be appreciated that models associated with text query 1104 that were not selected to be applied to search results may not be included in the information returned to the user or may not be displayed in the user interface. Furthermore, in scenarios such as FIG. 11 in which such associated models are returned to the user or are displayed, only a subset of such associated models may be returned to the user and/or displayed in the user interface.

In the example of FIG. 11, two chicken recipes are returned by the search stack and displayed in the web browser, returned information elements 1106 and 1108. Each of returned information elements 1106 and 1108 includes a picture 1110 and 1112, respectively, of chicken made according to the given recipe and a description 1114, and 1116, respectively, of the given recipe. In addition, returned information elements 1106 includes nutrition information 1118 displayed alongside description 1114, and returned information 1108 includes nutrition information 1120 displayed alongside description 1116. In the example of FIG. 11, nutrition information 1118 and 1120 are each computed as part of the application of the selected diet model 1124. Thus, each of nutrition information 1118 and 1120 includes a percentage of the recommended daily allowance (RDA) of particular nutritional items that a serving size of the item made according to the given recipe consumes, according to the “Diet 1” diet. In the example of FIG. 11, returned information elements 606 and 608 are returned as being sorted in descending order based on the percentage of RDA consumed by a serving size according to teach recipe, although any suitable sorting criteria may be used.

In the example of FIG. 11, the user interface allows the user to switch to have any other of the associated diet models 1122 be applied to search results returned in response to text query 1104 instead of the selected diet model 1124. The user may indicate that an alternate model be applied in any suitable way, for example, by clicking on an identifier (e.g., a name, such as, “Diet 2”), of another one of the associated diet models 1122. Selecting an alternate model to be used as the selected diet model 1124 may cause the search stack to compute the nutrition information based on specifications in the newly selected model, thereby also reflecting a change in the nutrition information returned to the user as part of the generated information and/or reflecting a change in the sorting order of the generated information. The user may therefore ascertain the differences between each model by comparing the effect on the generated information returned to the user based on the application of the model.

The user interface of FIG. 11 may also allow the user to select an additional model to be applied to search results in addition to whichever model is selected diet model 1124. For example, in FIG. 11, other models associated with text query 1104 besides diet models 1122 may also be returned as part of information generated by the search stack that is returned to the user. Thus, FIG. 11 illustrates category models 1126 that are also associated with text query 1104 and available to be applied to search results returned in response to the query. In the example of FIG. 11, category models include models to identify recipes made according to particular cooking methods (e.g., “skillet,” “breaded,” “stir-fry”) or models to identify recipes associated with particular ethnic cuisines (e.g., “Asian,” “Italian,” “Mexican”). Any one or more of these associated category models 1126 may be by the user to be applied to the search results returned in response to text query 1104 in addition to selected model 1124. Selecting one or more of category models 1126 may have the effect of filtering the generated information returned by the search stack to the user to only include recipes related to that category.

The user interface of FIG. 11 may allow the user to provide feedback relating to the usefulness of an applied model to the search stack. As discussed above, such feedback may be explicit or implicit. As an example of implicit user feedback, the length of time (e.g., session length) and/or number of mouse clicks related to the user actively navigating results returned from the search stack and displayed in the user interface of FIG. 11 may be taken as a measure of the usefulness of the applied model. In some embodiments, if the user spends a sufficient amount of time or issues a sufficient number of mouse clicks as part of navigating information returned to the user, this may be taken as an indication that the user was sufficiently interested in the returned information, and that the model was relevant to the search query. However, on the other hand, if the user spends an excessive amount of time or expends an excessive number of mouse clicks navigating search results, this may be taken as an indication that the generated information is not sufficiently relevant, and thus requires the user having to expend inordinate energy or time to find pertinent information. As another example of implicit feedback, if a user indicates that he would like to have another model applied instead of the currently applied model (e.g., the user clicks on another one of the diet models 1122 besides selected diet model 1124), this may be taken as an indication that the user is not fully satisfied with the results of currently applied model. However, any suitable techniques of implicitly indicating user feedback related to a model may be employed.

The user interface of FIG. 11 also allows the user to provide explicit feedback on an applied model. For example, the user interface includes rating link 1128, “Click Here to Rate Diet 1 Ranking.” When clicked on by a user, rating link 1128 allows a user to explicitly indicate the usefulness and/or relevance of an applied model to a given search query.

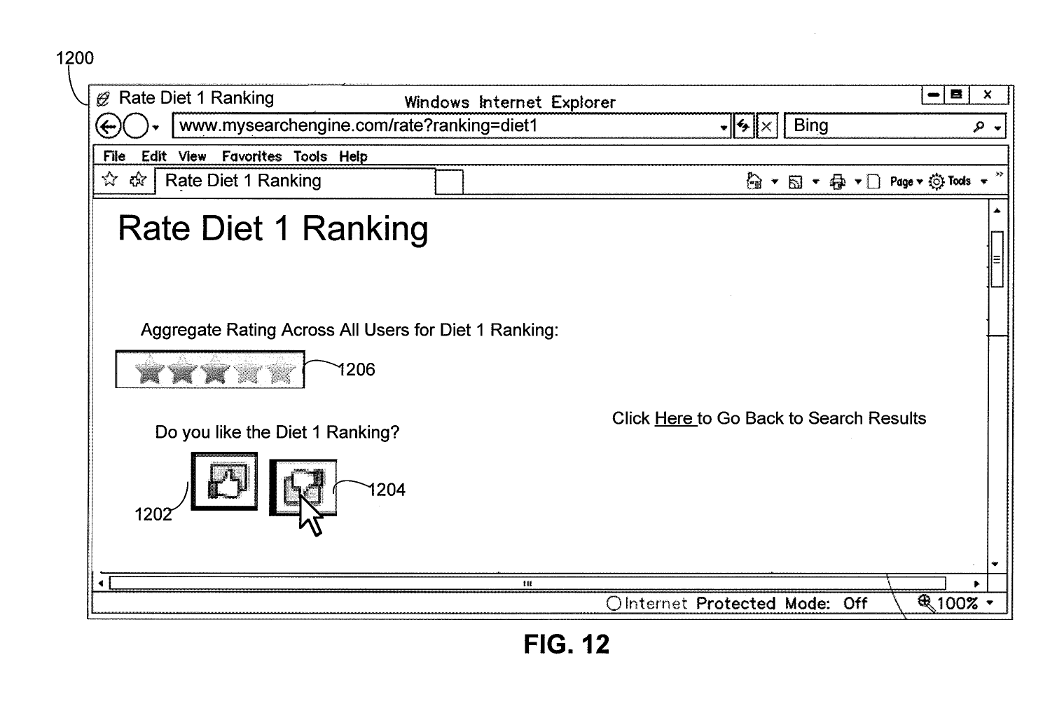

FIG. 12 is an example of a user interface that allows a user to explicitly provide feedback on an applied model. In this example, the user interface of FIG. 12 may be displayed when a user clicks on rating link 1128 in the user interface of FIG. 11. In the example of FIG. 12, the user may click on either of positive feedback control 1202 or negative feedback control 1204. A user's clicking on positive feedback control 1202 indicates that the user finds the given applied model (i.e., “Diet 1 Ranking”) to be useful and/or relevant, while the user's clicking on negative feedback control 1204 indicates that the user finds the given applied model to be not useful and/or not relevant. FIG. 12 also displays an aggregate rating 1206 that provides an indication of an aggregation of ratings of the given model made by all users who have provided feedback.

While the example of FIG. 12 illustrates a voting mechanism in which explicit feedback is provided as the selection of one of two choices, explicit feedback may be provided in any suitable way, including by entering free-form text in a text field, which may then be parsed and interpreted as natural language input by the search stack. Additionally, when the feedback is to be provided as one of a plurality of choices presented to a user in a range of choices arranged in order of increasing or decreasing relevance, usefulness, or value to the search query, any suitable number of choices or format may be available to the user. In particular, the user may be provided with more choices in a greater range than the two choices illustrated in FIG. 12. For example, the user may be allowed to choose integer ratings or “stars” in a range 1 . . . 5, alphabetical ratings in a range A . . . H, or semantic ratings (e.g., “completely irrelevant,” “mostly relevant,” “somewhat relevant,” “very relevant,” “perfectly relevant”).

Having thus described several aspects of at least one embodiment of this invention, it is to be appreciated that various alterations, modifications, and improvements will readily occur to those skilled in the art.

Such alterations, modifications, and improvements are intended to be part of this disclosure, and are intended to be within the spirit and scope of the invention. Accordingly, the foregoing description and drawings are by way of example only.

The above-described embodiments of the present invention can be implemented in any of numerous ways. For example, the embodiments may be implemented using hardware, software or a combination thereof. When implemented in software, the software code can be executed on any suitable processor or collection of processors, whether provided in a single computer or distributed among multiple computers.

Further, it should be appreciated that a computer may be embodied in any of a number of forms, such as a rack-mounted computer, a desktop computer, a laptop computer, or a tablet computer. Additionally, a computer may be embedded in a device not generally regarded as a computer but with suitable processing capabilities, including a Personal Digital Assistant (PDA), a smart phone or any other suitable portable or fixed electronic device.

Also, a computer may have one or more input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computer may receive input information through speech recognition or in other audible format.

Such computers may be interconnected by one or more networks in any suitable form, including as a local area network or a wide area network, such as an enterprise network or the Internet. Such networks may be based on any suitable technology and may operate according to any suitable protocol and may include wireless networks, wired networks or fiber optic networks.

Also, the various methods or processes outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

In this respect, the invention may be embodied as a computer readable medium (or multiple computer readable media) (e.g., a computer memory, one or more floppy discs, compact discs (CD), optical discs, digital video disks (DVD), magnetic tapes, flash memories, circuit configurations in Field Programmable Gate Arrays or other semiconductor devices, or other non-transitory, tangible computer storage medium) encoded with one or more programs that, when executed on one or more computers or other processors, perform methods that implement the various embodiments of the invention discussed above. The computer readable medium or media can be transportable, such that the program or programs stored thereon can be loaded onto one or more different computers or other processors to implement various aspects of the present invention as discussed above.

The terms “program” or “software” are used herein in a generic sense to refer to any type of computer code or set of computer-executable instructions that can be employed to program a computer or other processor to implement various aspects of the present invention as discussed above. Additionally, it should be appreciated that according to one aspect of this embodiment, one or more computer programs that when executed perform methods of the present invention need not reside on a single computer or processor, but may be distributed in a modular fashion amongst a number of different computers or processors to implement various aspects of the present invention.

Computer-executable instructions may be in many forms, such as program modules, executed by one or more computers or other devices. Generally, program modules include routines, programs, objects, components, data structures, etc. that perform particular tasks or implement particular abstract data types. Typically the functionality of the program modules may be combined or distributed as desired in various embodiments.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that conveys relationship between the fields. However, any suitable mechanism may be used to establish a relationship between information in fields of a data structure, including through the use of pointers, tags or other mechanisms that establish relationship between data elements.

Various aspects of the present invention may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments.

Also, the invention may be embodied as a method, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

What is claimed is:

1. A search and retrieval system comprising:
at least one processor for implementing a plurality of computer-executable components, the components comprising:
an authoring component adapted to generate a model based on input from a user, wherein the model defines computations to be performed on search results; and
an indexing component adapted to store in an index an association between the model and characteristics of a search query.

2. The search and retrieval system of claim 1, further comprising a computer storage medium, and wherein the authoring component is further adapted to store the generated model in the computer storage medium.

3. The search and retrieval system of claim 1, wherein receiving a model by the authoring component comprises receiving over the Internet a file comprising declarative statements.

4. The search and retrieval system of claim 1, wherein generating a model by the authoring component comprises:
receiving user input comprising declarative statements via the authoring component; and
generating the model based on the declarative statements.

5. The search and retrieval system of claim 1, wherein:
the user comprises a first user and the model comprises a first model; and
the authoring component is further adapted to receive input from a second user and to generate a second model based on the input from the second user.

6. The search and retrieval system of claim 5, wherein:
the indexing component is further adapted to store an association between the second model and the characteristics of a search query.

7. The search and retrieval system of claim 5, wherein:
the characteristics of a search query comprise characteristics of a first search query;
the association comprises a first association; and
the indexing component is further adapted to store in the index a second association between the second model and characteristics of a second search query.

8. The search and retrieval system of claim 7, further comprising:
a model selection component adapted to select one of the first model and the second model based at least in part on a comparison between a query received as input from a third user and the first and second associations stored in the index;
a model application engine adapted to apply the selected model on search results returned in response to the query received as input to generate information.

9. At least one non-transitory computer storage medium comprising computer-executable instructions that, when executed by at least one processor, perform a method within a search stack in a search system, the method comprising:
receiving feedback from a user related to a declarative model that has been used to generate information returned to the user in response to a search query; and
based on the received feedback, modifying an association stored in an index between the declarative model and characteristics of the search query.

10. The at least one non-transitory computer storage medium of claim 9, wherein receiving feedback from a user comprises receiving an explicit indication from the user of the relevance of the declarative model to the search query.

11. The at least one non-transitory computer storage medium of claim 9, wherein:
the declarative model comprises a first declarative model; and
receiving feedback from a user comprises receiving user input requesting that a second declarative model be used to generate information instead of the first declarative model.

12. The at least one non-transitory computer storage medium of claim 9, wherein receiving feedback from a user comprises monitoring at least one user behavior indicator selected from the group consisting of a session length in which the user navigates the generated information, a number of clicks the user makes in the generated information, and page exit paths.

13. The at least one non-transitory computer storage medium of claim 9, wherein:
the user comprises a first user;
the method further comprises receiving feedback from a second user related to the declarative model; and
modifying the association stored in the index between the declarative model and characteristics of the search query is performed based on an aggregation of the feedback received from the first user and the feedback received from the second user.

14. The at least one non-transitory computer storage medium of claim 9, wherein:
the declarative model comprises a first declarative model; and
modifying the association stored in the index between the declarative model and characteristics of the search query comprises associating terms of the search query with a second declarative model instead of with the first declarative model.

15. The at least one non-transitory computer storage medium of claim 9, wherein:
the index stores association scores, each respective association score indicating an association between a declarative model and a term;
the characteristics of the search query comprise a plurality of terms of the search query; and
modifying the association stored in the index between the declarative model and characteristics of the search query comprises, for each of the plurality of terms of the search query, modifying a respective association score indicating an association between the term and the declarative model.

16. A method of performing a search using a search system, the method comprising:
operating at least one processor to perform:
providing a declarative model to the search system;
sending a search query to the search system;
receiving information from the search system returned in response to the query, at least a portion of the information being generated by the search system by applying the declarative model; and
providing to the search system feedback related to the usefulness of the applied declarative model to the search query.

17. The method of claim 16, wherein providing a declarative model to the search system comprises:
using an authoring tool executing on the at least one processor:
receiving user input comprising declarative statements; and
generating a file to represent the model; and
sending the file to the search system over the Internet.

18. The method of claim 16, wherein providing a declarative model to the search system comprises sending user input comprising declarative statements to the search system.

19. The method of claim 16, wherein providing to the search system feedback related to the usefulness of the applied declarative model to the search query comprises sending to the search system a choice selected by a user from a plurality of choices presented to the user in order of relevance to the search query.

20. The method of claim 16, wherein providing to the search system feedback related to the usefulness of the applied declarative model to the search query comprises sending to the search system feedback that was explicitly provided by a user.
